(19) United States
(12) Patent Application Publication
(10) Pub. No.: US 2011/0208473 A1
(43) Pub. Date: Aug. 25, 2011

(54) METHOD FOR AN IMPROVED ESTIMATION OF AN OBJECT ORIENTATION AND ATTITUDE CONTROL SYSTEM IMPLEMENTING SAID METHOD

(76) Inventors: Cindy Bassompiere, Aigueblanche (FR); Andrea Vassilev, Grenoble (FR)

(21) Appl. No.: 13/054,259

(22) PCT Filed: Jul. 17, 2009
(86) PCT No.: PCT/EP2009/059225

§ 371 Date: Apr. 11, 2011

(30) Foreign Application Priority Data
Jul. 18, 2008 (FR) 08 04116

(51) Int. Cl. G06F 15/00

(52) U.S. Cl. 702/141

(57) ABSTRACT

A method of estimating the orientation of an object in space at time k using measurements of the total acceleration (y_{A}), magnetic field (y_{M}) and rotation speed (y_{G}) of said object along three spatial axes, comprising the following steps: A—preprocessing of said measurements (y_{A}, y_{M}, y_{G}) at a moment k to detect the existence of a disturbance in said measurements and estimate disturbance-free measurements at time k, B—estimation of the orientation (\hat{q}ₖ) at time k by an observer from the disturbance-free measurements (\tilde{y}_{A,k}, \tilde{y}_{M,k}, \tilde{y}_{G,k}) at time k obtained from the step A.

This application is a national phase application under §371 of PCT/EP2009/059225, filed Jul. 17, 2009, which claims priority to French Patent Application No. 0804116, filed Jul. 18, 2008, the entire content of which is expressly incorporated herein by reference.

The present invention relates to a method of estimating the orientation of an object in space, with or without proper acceleration and with or without magnetic disturbance, and to a device suitable for enabling the orientation to be estimated implementing said method.

Obtaining orientation generally involves using a number of sensors, forming part of an assembly designated as a motion capture device, also designated attitude control unit.

MEMS (Micro-Electro-Mechanical Systems) sensors can be used to construct this control unit, said MEMS sensors having the advantage of being small and inexpensive. The use of such MEMS sensors makes it possible to consider the use of attitude control units in various fields of application, notably the biomedical domain, for the monitoring of home-based elderly people, functional re-education, in the sporting domain, for the analysis of sports movements, in the automobile, robotics, virtual reality and three-dimensional animation domains, and more generally in any domain in which there is a need to determine or observe a movement.

However, compared to non-MEMS sensors (used, for example, in the navigation domain), these MEMS sensors have the drawbacks of being relatively noise- and bias-affected.

Moreover, it is known that there are attitude control units that use both accelerometers and magnetometers, which make it possible to reconstruct movements with three degrees of freedom, that is to say movements for which the proper accelerations and the magnetic disturbances are respectively negligible compared to the earth's gravity field and the earth's magnetic field. However, when this assumption is not observed, that is to say, the proper acceleration or magnetic disturbances cannot be disregarded, the movements exhibit six or nine degrees of freedom. It is then impossible, using an attitude control unit that uses only accelerometers and magnetometers to estimate the orientation of the moving object. That said, the diversification of motion capture applications makes it essential to overcome these constraints.

Consideration has therefore been given to the use of additional sensors, more particularly the combined use of rate gyros, accelerometers and magnetometers. The measurements obtained from these sensors are made up of two parts: an informative part directly linked to the orientation of the moving object and a disturbing part, the nature of which depends on the sensor concerned. Firstly, these are proper accelerations for the measurements supplied by the accelerometers, magnetic disturbances for the measurements delivered by the magnetometers and bias for the rate gyros. These disturbances lead to an incorrect orientation estimation. Currently, there are a number of methods for obtaining, from measurements supplied by accelerometers, magnetometers and rate gyros, an estimation of the orientation of the object.

There are so-called optimization methods that implement one or more optimization criteria, but these are relatively costly in terms of computation times. Furthermore, when the problem becomes complex, defining the optimization criteria is difficult.

There are also methods that implement neural networks, the latter requiring a consequent learning phase, notably with regard to the size of the database and the computation time, to obtain an accurate estimation.

Moreover, for the optimization methods and those that implement neural networks, it is difficult to take account of the concept of state trend over time, which makes them less robust.

There are also methods that implement an observer, which, unlike the abovementioned methods, make it possible to merge information from two sources: information originating from the measurements supplied by the sensors and information originating from a trend model, and do so while maintaining a computation time that is compatible with a real-time implementation.

The known methods that use an observer rely mainly on the use of a Kalman filter. The advantage of this technique is that it allows for the merging of the data while taking account of the quality of the information provided by the measurements supplied by the sensors and the quality of the model.

There are a number of types of Kalman filter, well known to those skilled in the art:
The extended Kalman filter (or EKF); this is quick and easy to implement and one of its applications to motion capture is notably described in the document “Quaternion-based extended Kalman filter for determination orientation by inertial and magnetic sensing”, SABATINI A. M., IEEE Transactions on Biomedical Engineering, 2006, 53(7).
The UKF Kalman filter (Unscented Kalman Filter), dedicated to strongly nonlinear problems. As it happens, in the context of motion capture, the problems encountered are weakly nonlinear; consequently, it is less appropriate for estimating orientation. Moreover, the computation cost is greatly increased compared to an EKF filter. It is therefore of less interest than an EKF filter. For example, the document “Portable orientation estimation device based on accelerometers, magnetometers and gyroscope sensors for sensor network” by HARADA T., UCHINO H., MORI T., SATO T. IEEE Conference on Multisensor Fusion and Integration for Intelligent Systems, 2003, describes a portable orientation estimation device in which the absolute orientation is merged by means of an accelerometer and a magnetometer and the rotation speed is merged by means of a UKF filter.
The complementary Kalman filter: in this case in point, the aim is to estimate the error on the states and not the states themselves, and it is very complex to implement.

In addition to the choice of filter, the quality of the measurements injected into the filter, and notably the trustworthiness of their value, is of great importance.

In practice, as mentioned previously, the measurements include an informative part that is directly linked to the orientation of the moving object and a disturbing part, the nature of which depends on the sensor concerned. Firstly, these are proper accelerations for the measurements supplied by the accelerometers, magnetic disturbances for the measurements delivered by the magnetometer and bias for the rate gyros. It is also necessary to take account of the measurement noise, but said noise is conventionally processed in the filter.

There are currently a number of methods for processing the disturbances. One of them consists in considering the disturbances to be negligible and supplying the filter with the measurements as delivered by the sensors, as is the case in the documents “Design, implementation and experimental results of a quaternion-based Kalman filter for human body motion tracking”, YUN X., BACHMANN E. R. IEEE Transactions On Robotics, 2006, 22(6), and “Application of MIMU/Magnetometer integrated system on the attitude determination of micro satellite”, SU K., REN D. H., YOU Z., ZHOU Q., International Conference on Intelligent Mechatronics and Automation, August 2004, Chengdu, China. Consequently, in the case where a disturbance actually occurs on one of the sensors, the measurement supplied by the filter is errored but the filter will consider it to be exact. The estimation of the orientation then becomes incorrect. It is therefore not possible to neglect the disturbances to obtain an estimation with the desired accuracy, regardless of the number of degrees of freedom. Performance levels are therefore greatly degraded, since the disturbed measurements are supplied as such to the observer.

Estimation methods therefore make it possible to take account of the one-off imperfection in certain measurements by detecting the presence of disturbances and by updating the trustworthiness of these measurements, as is for example described in the document “Portable orientation estimation device based on accelerometers, magnetometers and gyroscope sensors for sensor network”, HARADA T., UCHINO H., MORI T., SATO T. IEEE Conference on Multisensor Fusion and Integration for Intelligent Systems, 2003. This method provides an additional step for detecting disturbance in the measurements. When a disturbance is detected, the trust in the corresponding measurement is minimized.

The information provided by the measurement including a disturbance is not therefore taken into account in estimating the orientation. The estimation of the orientation then relies only on the measurements supplied by the other sensors. Now, in the case where the measurements from a number of sensors simultaneously exhibit a disturbance, the observer no longer has enough information to offer a correct orientation estimation.

There is finally a method described in the documents “Inertial and magnetic sensing of human motion”, ROETENBERG D., doctoral thesis, Twente university, Netherlands, 2006, and “Measuring orientation of human body segment using miniature gyroscopes and accelerometers”, PhD Thesis, Inertial sensing of human movement, LUINGE H. J. n 2002b, in which provision is made to detect the presence of disturbances and estimate them, by virtue of the observer. For this, the state vector is augmented and the disturbances occur in the measurement model which becomes closer to reality. This technique seems, in principle, to be suited to the case of movements with six or nine degrees of freedom. However, the combined estimation of the disturbances and of the orientation is difficult because of a lack of observability. It also requires a large number of parameters to be set, which increases the complexity of its implementation.

It is therefore one aim of the present invention to offer an orientation estimation method that provides an accurate orientation estimation, regardless of whether proper accelerations and magnetic disturbances are present, and do so in a simplified manner compared to the existing methods.

The previously stated aim is achieved by a method of estimating orientation on the basis of measurements along the three spatial axes of acceleration, magnetic field and rotation speed, comprising:
a step for preprocessing these measurements to detect the existence of a disturbance and estimate disturbance-free measurements, and
a step for estimating the orientation on the basis of the measurement values obtained from the preprocessing step.

The method does not disregard the disturbances, which means that the estimation is not errored; it constantly estimates them. If they exist, it does not reject the associated measurement or measurements, as in the case of other estimation methods. Furthermore, it does not incorporate them in the state vector or in the measurement model, which simplifies the model and does not lead to situations in which estimation becomes impossible.

Provision is therefore made to estimate the orientation, and possibly estimate the disturbances, in two successive steps. The observer is therefore provided with measurements from the accelerometers, magnetometers and rate gyros that are as close as possible to ideal conditions for estimating orientation: that is to say, without proper accelerations, without magnetic disturbances and without bias, respectively.

For this, provision is made to use the orientation estimated at the preceding moment as additional information for performing the preprocessing of the measurements.

The estimation method according to the invention therefore makes it possible to extract, from the sensor measurements, the orientation of the object in an optimal manner, regardless of the movement concerned. This method is, moreover, simple to implement and comprises only a small number of setting parameters.

The observer is advantageously an extended Kalman filter.

Provision can be made to estimate the disturbances, notably the proper accelerations, which makes it possible, by integration and double-integration, to get back to the speed and the position of the object respectively.

The main subject of the present invention is therefore a method of estimating the orientation of an object in space at time k using the measurements of the total acceleration, magnetic field and rotation speed of said object along three spatial axes, comprising the following steps:

A—preprocessing of said measurements at a moment k to detect the existence of a disturbance in said measurements, said disturbance belonging to a group comprising a proper acceleration of the object, a magnetic field added to the earth's magnetic field and a bias in the measurement of the rotation speed, and to estimate disturbance-free measurements at time k,

B—estimation of the orientation at time k by an observer from the estimated disturbance-free measurements at time k obtained from the step A.

The step A advantageously comprises:

A1—a preprocessing of the rotation speed measurements,

A2—a detection of the existence or non-existence of a disturbance at time k in said measurements of the total acceleration and magnetic field,

A3—in case of absence of disturbance at time k, the estimated disturbance-free measurement at time k is equal to the measurement at time k, and in case of disturbance, the disturbance-free measurement estimated at time k is calculated on the basis of the orientation estimated at the preceding moment k−1.

The step A1 consists in subtracting, from the rotation speed measurements, an average bias determined during a preliminary initialization step. This average bias can be obtained by immobilizing the means supplying the rotation speed measurements during a given time and calculating the average of the values of the rotation speed measurements on each axis. In the case of an attitude control unit worn by a person, this immobilization entails removing the control unit from the person to do away with the inevitable tremors of the person.

The step A2 for preprocessing the acceleration and magnetic field measurements may comprise:
a step A2.1 consisting of a test to compare the norm of the total acceleration measurements to that of the gravitational field, if the absolute value of the difference between the norm of the accelerometric measurements at time k and that of the gravitational field is below a predetermined threshold, it is assumed that the accelerometric disturbance is zero, otherwise it is assumed that there is a disturbance, the disturbance being equal, on each axis, to the difference between the measurement of the total acceleration on each axis at time k and the disturbance-free accelerometric measurement estimated at time k, and
a step A2.2 consisting of a test to compare the norm of the magnetic field measurements to that of the earth's magnetic field, if the absolute value of the difference between the norm of the magnetic field measurements and that of the earth's magnetic field is below a predetermined threshold, it is assumed that the magnetic disturbance is zero, otherwise it is assumed that the magnetic disturbance is equal, on each axis, to the difference between the magnetic field measurement at time k and the disturbance-free magnetic field measurement estimated on each axis at time k.

Provision is advantageously made in the step A2.1 for an additional test on the estimated disturbance at time k−1: in the case where the absolute value of the difference between the norm of the measurements of the total acceleration and that of the gravitational field at time k is below the predetermined threshold, a check is carried out to see whether the norm of the estimated accelerometric disturbance at time k−1 is below a predetermined threshold, if this test is positive, it is assumed that the accelerometric disturbance is effectively zero at time k, and/or provision is made in the step A2.2 for an additional test on the estimated magnetic disturbance at time k−1: in the case where the absolute value of the difference between the norm of the magnetic field measurements and that of the earth's magnetic field is below the predetermined threshold, a check is carried out to see whether the absolute value of the estimated magnetic disturbance at time k−1 is below a predetermined threshold, if this test is positive, it is assumed that the magnetic disturbance is effectively zero at time k. This additional step makes it possible to improve the accuracy of the estimation method.

In unfavorable cases of use in which it is known that the estimated orientation may drift, the robustness of these comparison tests of the steps A2.1 and A2.2 is however assured only over a limited time window, which differs depending on circumstances. The comparison tests are therefore advantageously performed over time bands as indicated later in the description. Thus, using \tilde{y}_{A,k}, \tilde{y}_{M,k}, \tilde{y}_{G,k} to denote the measurements obtained on completion of the preprocessing step, which are called estimated disturbance-free measurements:
the detection of proper accelerations is performed only by virtue of the norm of the accelerometric measurement; if this norm is different from the norm of G₀ (earth's gravity) on at least one of the measurements of a sliding window of duration T_{A} then the measurement at the current moment is considered to be disturbed;
the detection of the magnetic disturbances is performed in a similar manner:
   if the norm of the magnetometric measurement is different from the norm of H₀ (earth's magnetic field) on at least one of the measurements of a sliding window of duration T_{M}
   OR if the angle between the magnetometric measurement and the opposite of the disturbance-free accellerometric measurement −\tilde{y}_{A} is different from the angle between the vectors G₀ and H₀,
then the measurement at the current moment is magnetically disturbed.

T_{A} may be a parameter of constant value whereas the value of T_{M} may be linked to the speed of the movement.

By using this variant, which can be located on the same equipment and activated by the user, there is no need to look for the values of the measurements at time k−1 and the drift is therefore dispensed with.

The observer used in the step B is preferably an extended Kalman filter, which is quick and easy.

The step B for estimating the orientation from measurements estimated at time k may comprise:
the estimation of the a priori state vector at time k, from the state vector estimated a posteriori at time k−1,
the estimation of the a priori measurements at time k, from the estimation of the a priori state vector at time k, called a priori estimation of the measurements
calculation of the gain of the extended Kalman filter and of the innovation by calculating the difference between the disturbance-free measurements estimated at time k and the a priori estimated measurements,
calculation of the estimated orientation at time k by correction of the state vector estimated a priori at time k by the gain and the innovation.

The state vector used in the extended Kalman filter may contain the elements of the angular speed and of the orientation quaternion.

The state vector used in the extended Kalman filter advantageously contains only the elements of the orientation quaternion, which makes it possible to simplify the structure of the state and measurement models.

Also the subject of the present invention is an attitude control unit comprising means suitable for supplying acceleration measurements, means of measuring the magnetic field, and means of measuring the rotation speed along three spatial axes, said means being intended to be joined in movement to an object, and means of estimating an orientation at time k on the basis of the measurements supplied by said measurement means, said estimation means comprising:
means of preprocessing said acceleration, magnetic field, and rotation speed measurements, said preprocessing means being suitable for detecting the existence of a disturbance in said measurements and for delivering estimated disturbance-free accelerometric measurements, estimated disturbance-free magnetometric measurements, and the non-biased rotation speed,
means of estimating the orientation at a moment k by an observer from the measurements supplied by the preprocessing means. This observer may be an extended Kalman filter.

The attitude control unit according to the present invention may also comprise means of calculating an average bias of the rotation speed measurement means during a control??.

The preprocessing means comprise means of detecting the existence of a proper acceleration in the acceleration measurements and means of detecting the existence of magnetic disturbances in the magnetic field measurements.

The attitude control unit according to the invention may also comprise means of estimating the proper acceleration and of calculating the speed and the position of the object.

The means suitable for supplying total acceleration measurements, magnetic field measurements and rotation speed measurements along three spatial axes are advantageously MEMS sensors.

The present invention will be better understood from the following description and the appended drawings in which:

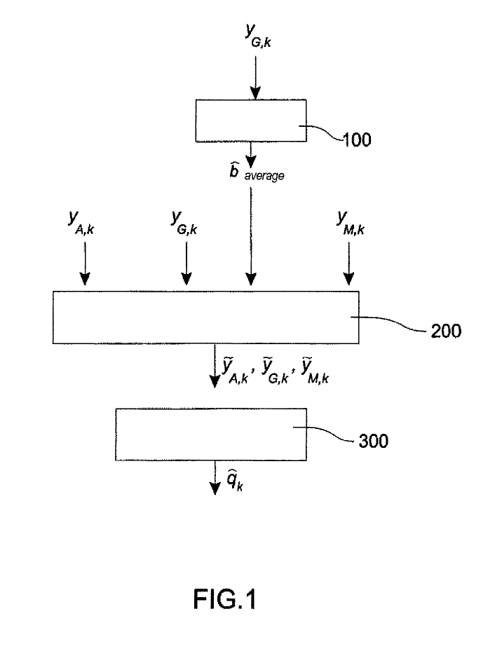

FIG. 1 is a flow diagram of the method according to the present invention at time k,

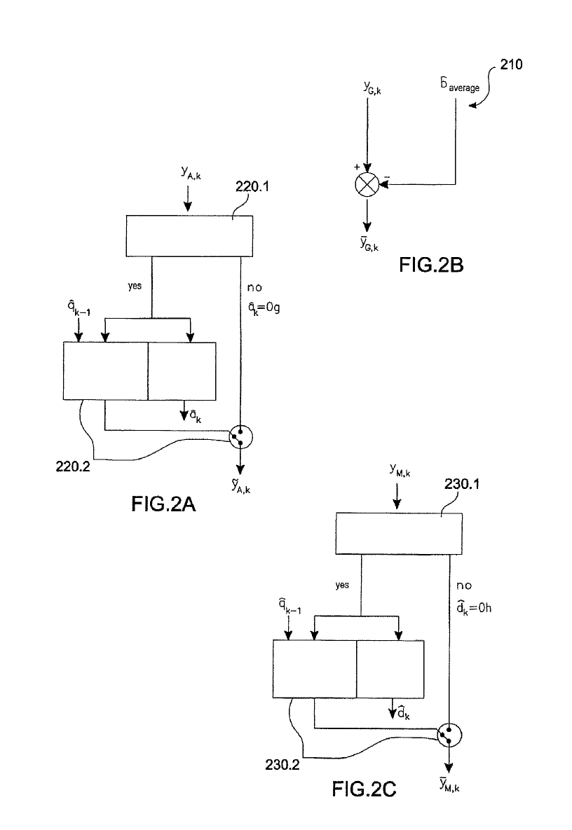

FIGS. 2A to 2C represent detailed flow diagrams of a step for preprocessing the measurements from an accelerometer, a rate gyro and a magnetometer respectively, according to the present invention.

The aim is to obtain the orientation of an object moving in space, for example the orientation of a person. For this, an attitude control unit is used which comprises sensors suitable for supplying total acceleration, magnetic field and rotation speed measurements along the three spatial axes. The sensors are advantageously MEMS sensors that offer a reduced cost price and a limited footprint.

For the acceleration measurement, it may be, for example, a triaxial accelerometer or three uniaxial accelerometers supplying a measurement on each of the axes.

Similarly, for the magnetic field measurements, it may be a triaxial magnetometer or three uniaxial magnetometers.

For the rotation speed measurement, it may be, for example, three uniaxial rate gyros or advantageously two biaxial rate gyros.

The triaxes may be aligned or not, but in the latter case, the relative orientation between the axes must be known.

Hereinafter in the description, in the interests of simplicity, we will designate the accelerometer or accelerometers as an accelerometer, the magnetometer or magnetometers as a magnetometer and the rate gyro or rate gyros as a rate gyro. These sensors are attached to the object for which the orientation is to be known.

We have only the measurements y, that we will model by:

$$\{ \begin{matrix}{y}_{A} = - R \cdot {G}_{0} + a + {v}_{A} \\ {y}_{M} = R \cdot {H}_{0} + d + {v}_{M} \\ {y}_{G} = ω + b + {v}_{G}\end{matrix} \qquad ( I )$$

with y_{A}: triaxial measurement of the total acceleration supplied by the accelerometer,
   y_{M}: triaxial measurement of the magnetic field supplied by the magnetometer,
   y_{G}: triaxial measurement of the rotation speed supplied by the rate gyro,
   R: rotation matrix,
   G₀: earth's gravity field (vector 3×1),
   H₀: earth's magnetic field (vector 3×1),
   ω: angular speed,
   a: proper accelerations,
   d: magnetic disturbances,
   b: rate gyro bias,
   v_{A}: accelerometer measurement noise,
   v_{M}: magnetometer measurement noise,
   v_{G}: rate gyro measurement noise.

The orientation is estimated relative to a reference coordinate, entirely defined by the datum of the vectors G₀ and H₀. For example, the geocentric coordinate is defined by the vectors G₀ (0; 0; 1) and H₀ (0.5; 0; \sqrt{3}/2).

In the interests of simplicity, we will not differentiate the measurements in the three spatial directions.

As will clearly emerge from the mathematical definition (I) of the measurements, each of these measurements respectively comprises a first part “−RG_{O}”, “R·H_{O}” and ω, which contains the information with which to obtain an estimation of the orientation, a second part a, d and b which represents the possible disturbances that may appear, randomly, in the measurements, and finally a third part v_{A}, v_{M}, V_{G} representing the measurement noise on each sensor.

In the method according to the present invention, provision is made after the collection of the measurements for a preprocessing step before the measurements are used in a processing step intended to provide an estimation of the orientation.

FIG. 1 shows a general flow diagram of the method according to the present invention.

In the following description of the method, the estimation of the orientation at time k, k being a proper integer greater than or equal to 2, is taken as an example.

The method according to the present invention comprises a step 100 of initialization of the attitude control unit, a step 200 of preprocessing of the measurements supplied by the sensors and a third processing step 300 by the observer. Each of the steps will be described in detail hereinafter in the description.

Before describing the various steps of the method according to the invention in detail, we will describe the observer. Advantageously, the observer used in the measurements processing step is an extended Kalman filter, which is simple, robust and quick to implement.

This filter is widely known to those skilled in the art and will not be described in detail. We will give only the mathematical expressions of the state model and of the measurement model.

A Kalman filter comprises a state model defining the temporal and dynamic trend of the states, and a measurement model which is used to link the sensor measurements and the states.

The state vector of the Kalman filter consists, according to a first modeling, the three elements of the angular speed and of the four elements of the quaternion defining the orientation.

The associated state and measurement models may be, respectively:

$$\dot{x} = f ( x ) = ( \begin{matrix}\dot{ω} \\ \dot{q}\end{matrix} ) = ( \begin{matrix}- \frac{1}{τ} \cdot ω \\ \frac{1}{2} \cdot q ⊗ ω\end{matrix} ) + {w}_{x}$$

$$y = h ( x ) = ( \begin{matrix}{y}_{G} \\ {y}_{A} \\ {y}_{M}\end{matrix} ) = ( \begin{matrix}ω \\ - \overline{q} ⊗ {G}_{0} ⊗ q \\ \overline{q} ⊗ {H}_{0} ⊗ q\end{matrix} ) + ( \begin{matrix}{v}_{G} \\ {v}_{A} \\ {v}_{M}\end{matrix} )$$

with x: state vector
ω: angular speed
q: quaternion
τ: time constant of the evolution model of the angular speed
y: measurements
wₓ: modeling noise

For simplicity, the vector quaternion [0, G₀] of dimension 4×1 is identified with the vector G₀ of dimension 3×1 and the same applies for the vector quaternion [0, H₀] of dimension 4×1, the vector H₀ also being of dimension 3×1.

Advantageously, according to a second modeling, a state vector can be used that contains only the elements of the quaternion, the latter being of no more than dimension 4, whereas it is of dimension 7 in the first modeling. The gyrometric measurement is then injected directly into the state model and the measurement vector contains only the measurements from the accelerometer and the magnetometer.

The state model and the measurement model can then be expressed:

$$\begin{matrix}\dot{x} = f ( x ) = \dot{q} = \frac{1}{2} \cdot q ⊗ {y}_{G} + {w}_{x} , \\ and & ( II ) \\ y = h ( x ) = ( \begin{matrix}{y}_{A} \\ {y}_{M}\end{matrix} ) = ( \begin{matrix}- \overline{q} ⊗ {G}_{0} ⊗ q \\ \overline{q} ⊗ {H}_{0} ⊗ q\end{matrix} ) + ( \begin{matrix}{v}_{A} \\ {v}_{M}\end{matrix} ) & ( III )\end{matrix}$$

This second modeling can be used to simplify the structure of the state and measurement models since their dimension is directly reduced. Moreover, the number of setting parameters, notably the elements of the covariance matrices of the modeling noise, of the measurement noise and of the state vector estimation error, is also restricted, which makes it easier to implement this method. The estimation results obtained in this way are of a similar accuracy to those obtained using the first modeling.

We will now describe in detail the steps 100, 200 and 300 according to the present invention.

The initialization step 100 provides for the average disturbance of the rate gyro to be estimated. This disturbance b, which is in fact the bias of the rate gyro, varies between two limit values.

For the initialization step (k=1):

Either the proper acceleration a₁ and the magnetic disturbance d₁ is known at the initial moment, in which case the initialization step includes determination of the state vector x₁: the angular speed is assumed zero at the initial moment, the quaternion is determined by optimization using the corrected acceleration and magnetic field measurements of the disturbances a₁ and d₁; or the orientation in the initial state is known, in which case a₁ and d₁ can be deduced.

The step 100 for initializing the control unit at k=1 also comprises:
the setting of the covariance matrices Q, R and P₁ respectively linked to the modeling noise, to the measurement noise and to the initial state vector estimation error;
the calculation of an estimation of the bias b, denoted \hat{b}_{average}: the attitude control unit is kept immobile for a determined time, for example approximately a second, and the average of the output values from the rate gyro on each axis is calculated. This estimation of the average bias \hat{b}_{average} is, subsequently, subtracted from each measurement of the rate gyro during the preprocessing step 200, which makes it possible to minimize the influence of the bias and thus improve the accuracy of the results obtained. This estimation of the average bias \hat{b}_{average} preferably takes place at the start of each acquisition. Provision can also be made for this estimation to be refreshed during periods of immobility.

FIGS. 2A to 2C show the detail of the steps of the method according to the invention.

During the step 200, the measurements delivered by the three sensors are preprocessed during three steps 210, 220 and 230. Depending on the context in which the method is used and the desired accuracy, there are a number of possible variant embodiments.

The first step 210 is identical in all the embodiments. During this step 210, represented in FIG. 2B, the measurement y_{G,k} from the rate gyro is preprocessed. As indicated above, this preprocessing of the measurement y_{G,k} is obtained by subtracting from the real measurement the average bias \hat{b}_{average}, and a preprocessed measurement from the rate gyro at time k, designated \tilde{y}_{G,k} is obtained as output.

In the description, the acceleration is given in multiples of G₀ (earth's magnetic field), and the magnetic field is given as multiples of H₀ in the interests of simplicity.

In a first embodiment, two tests are performed, advantageously in parallel, to detect the existence of accelerometric disturbances (step 220) and magnetometric disturbances (step 230). During the step 220, the measurements delivered by the accelerometer y_{A,k} at time k are preprocessed. This step 220 comprises a first substep 220.1 for detecting the existence or nonexistence of a disturbance, i.e. of a proper acceleration a, and a second substep 220.2 for construction of a preprocessed measurement of the acceleration \tilde{y}_{A,k} on the basis of the orientation estimated at the preceding moment k−1.

During the step 220.1, in order to detect the existence or nonexistence of a proper acceleration a, the norm of the measurement y_{A,k} is compared to the norm of the gravitational field (as a reminder, the method works in multiples of G₀), so a comparison is therefore made relative to 1:

If |∥y_{A,k}∥−1|<α_{A},

Advantageously, if the test is positive, the following test is added:

|âₖ₋₁|<β_{A}

The comparison of the norm of the proper acceleration estimated at time k−1, âₖ₋₁, at β_{A}, is advantageously used to exclude particular cases for which the first test is insufficient. In practice, it is assumed that if, at time k−1, the proper acceleration has a high value, i.e. greater than β_{A}, it is improbable that, at time k, the proper acceleration will be less than β_{A}. α_{A} and β_{A} are, for example, equal to 0.04 and 0.2 respectively.

This second test therefore improves the accuracy of the estimation of the disturbance-free measurement \tilde{y}_{A,k} and therefore of the estimation of the orientation.

If the above two tests are positive, a decision is then made that the proper acceleration âₖ is zero at time k. During the step 220.2, the estimated measurement is then equal to y_{A,k} and can be used directly by the observer.

âₖ=0

\tilde{y}_{A,k}=y_{A,k}

Otherwise, during the step 220.2, a new acceleration measurement is constructed by virtue of the estimated orientation \hat{q}ₖ₋₁, estimated at the preceding moment.

The disturbance-free accelerometric measurement estimated at time k is then expressed using the measurement model:

\tilde{y}_{A,k}=−{circumflex over ( q̅ₖ₋₁ [symbol] G₀ [symbol] \hat{q}ₖ₋₁,

A value of the proper acceleration âₖ at time k can also be deduced therefrom (step 220.3), which makes it possible by integration and double integration respectively to deduce therefrom the speed and the position of the object.

The proper acceleration is equal to:

ãₖ=y_{A,k}+{circumflex over ( q̅ₖ₋₁ [symbol] G₀ [symbol] \hat{q}ₖ₋₁, since y_{A,k}=\tilde{y}_{A,k}+âₖ

During the step 230, similar to the step 220, the measurements delivered by the magnetometer y_{M,k} at time k are preprocessed. This step 230 comprises a first substep 230.1 for detection of the existence or nonexistence of a magnetic disturbance d, and a second substep 230.2 for construction of a preprocessed measurement of the magnetic field \tilde{y}_{M,k} on the basis of the orientation estimated at the preceding moment k−1.

During the step 230.1, in order to detect the existence or nonexistence of a magnetic disturbance d, the norm of the measurement y_{M,k} is compared to the norm of the magnetic field (as a reminder, the method works in multiples of H₀), so a comparison is therefore made relative to 1:

If |∥y_{M,k}∥−1|<α_{M},

Advantageously, in case of a positive test for nonexistence of a disturbance of the magnetic field, the following test is added:

|\hat{d}ₖ₋₁|<β_{M}

The comparison of the norm of the magnetic disturbance estimated at time k−1, \hat{d}ₖ₋₁, at β_{M}, can advantageously be used to exclude particular cases for which the first test is insufficient. In practice, it is assumed that if, at time k−1, the magnetic disturbance has a high value, i.e. greater than β_{M}, it is improbable that, at time k, the magnetic disturbance is less than β_{M}. α_{M} and β_{M} are, for example, equal to 0.04 and 0.2 respectively.

This second test therefore improves the accuracy of the estimation of the disturbance-free measurement \tilde{y}_{M,k} and therefore of the estimation of the orientation.

If the above two tests are positive, a decision is then made that the magnetic disturbance \hat{d}ₖ is zero at time k. During the step 230.2, the estimated measurement is then equal to y_{M,k} and can be used directly by the observer.

dₖ=0

\tilde{y}_{M,k}=y_{M,k}

Otherwise, during the step 230.2, a new measurement of the magnetic field is constructed by virtue of the estimated orientation \hat{q}ₖ₋₁, estimated at the preceding instant.

The disturbance-free magnetometric measurement estimated at time k is then expressed using the measurement model:

\tilde{y}_{M,k}={circumflex over ( q̅ₖ₋₁ [symbol] H₀ [symbol] \hat{q}ₖ₋₁,

A value of the magnetic disturbance at time k can also be deduced therefrom (step 230.3), which is equal to:

\hat{d}ₖ=y_{M,k}−{circumflex over ( q̅ₖ₋₁ [symbol] H₀ [symbol] \hat{q}ₖ₋₁, since y_{M,k}=\tilde{y}_{M,k}+\hat{d}ₖ

A second embodiment is particularly applicable in cases where it is known that the estimation of the orientation may drift significantly. In these cases, it is advantageous to define time windows in which the tests for existence of accelerometric and magnetometric disturbances are performed.

In this variant, for the accelerometric measurements test, the comparison provided for in the step 220 is performed over a window that ends at the moment tₖ: if a proper acceleration is detected (norm of the accelerometric measurements different from the norm G₀ to within α_{A} on at least one of the measurements of the window [tₖ−T_{A}; tₖ]), then the disturbance-free accelerometric measurement is constructed by virtue of the orientation estimated at the preceding moment; otherwise, the disturbance-free accelerometric measurement is equal to the measurement involved in the preprocessing phase (sensor measurement). The value of the proper acceleration is calculated from the sensor measurement. Typical values given only as examples for α_{A} and T_{A} are 0.2 g and 0.4 s.

The test for absence of a proper acceleration is then expressed:

If |∥y_{A,k}∥ − ∥G₀ ∥| < α_{A}, ∀tₖ∈[tₖ − T_{A}; tₖ]
âₖ = 0
\tilde{y}_{A,k} = y_{A,k}
Else
\tilde{y}_{A,k} = − \overline{\hat{q}}ₖ₋₁ [symbol] G₀ [symbol] \hat{q}ₖ₋₁

Advantageously, the proper acceleration may be calculated systematically, even in the case where thresholds are not exceeded, by the same formula as in the first variant embodiment:

âₖ=y_{A,k}+{circumflex over ( q̅ₖ₋₁ [symbol] G₀ [symbol] \hat{q}ₖ₋₁

Then, or in parallel (this second option being advantageous since it provides for a time saving) the test for detection of disturbances of the magnetometric signal provided for in the step 230 is carried out: if a magnetic disturbance is detected (norm of the magnetometric measurements different from the norm of H₀ to within α_{M} on at least one of the measurements of the window [tₖ−T_{M}; tₖ]), then the disturbance-free magnetometric measurement is constructed by virtue of the orientation estimated at the preceding moment. Otherwise, the disturbance-free magnetometric measurement is equal to the measurement involved in the preprocessing phase (sensor measurement). The value of the magnetic disturbance is then calculated from the sensor measurement. Typical values given only as examples for α_{M} and T_{M} are respectively 0.1 h and 0.5 s.

The test for nonexistence of a disturbance is then expressed:

If |∥y_{M,k}∥ − ∥H₀∥| < α_{M}, ∀tₖ∈[tₖ − T_{M}; tₖ]:
\hat{d}ₖ = 0
\tilde{y}_{M,k} = y_{M,k}
else
\tilde{y}_{M,k} = q̅ₖ₋₁ [symbol] H₀ [symbol] qₖ₋₁
End if

Advantageously, the magnetic disturbance can be calculated systematically even in cases where thresholds are not exceeded, by the same formula as in the first variant embodiment:

\hat{d}ₖ=y_{M,k}−{circumflex over ( q̅ₖ₋₁ [symbol] H₀ [symbol] \hat{q}ₖ₋₁

In these first two embodiments, the steps 202 and 203 are advantageously performed in parallel.

On the other hand, a third embodiment can be used to enhance the accuracy of the detection, when this is necessary and when the device includes sufficient computation storage means to use trigonometric functions. In this case, the advantage obtained by the parallel performance of the detection calculations is dispensed with and it is more advantageous to perform the test for the existence of magnetic disturbance after the test for the presence of a proper acceleration. At the output of this first calculation of step 202, uₖ=angle(−\tilde{y}_{A,k}, y_{M,k}) is also calculated and u₀ is used to denote the angle measured between the vectors G₀ and H₀. This parameter can then be calculated during the initialization step 100. Then, the test for detection of magnetic disturbance is performed as follows: if a magnetic disturbance is detected (norm of the magnetometric measurements different from the norm of H₀ to within α_{M} or angle uₖ different from u₀ to within αᵤ on at least one of the measurements of the window [tₖ−T_{M}; tₖ]), then the disturbance-free magnetometric measurement is constructed by virtue of the orientation estimated at the preceding moment. Otherwise, the disturbance-free magnetometric measurement is equal to the measurement involved in the preprocessing phase (sensor measurement). The value of the magnetic disturbance is then calculated from the sensor measurement.

Advantageously, two different values of T_{M} will be used depending whether a proper acceleration is present or not (respectively T_{M}_{_{—}}_{fast} and T_{M}_{_{—}}_{slow}). Typical values given only as examples for α_{M}, αᵤ, T_{M}_{_{—}}_{fast} and T_{M}_{_{—}}_{slow} are respectively 0.1 h, 10°, 0.5 s and 3 s.

The test for existence of a disturbance is then expressed:

If a proper acceleration is present
T_{M} = T_{M}_fast
else
T_{M} = T_{M}_slow
End if
If |∥y_{M,k}∥ − ∥H₀∥| > α_{M} or |uₖ − u₀| > αᵤ for at least one value tₖ such that
tₖ∈[tₖ − T_{M}; tₖ]:
\tilde{y}_{M,k} = q̅ₖ₋₁ [symbol] H₀ [symbol] qₖ₋₁
else

\tilde{y}_{M,k} = y_{M,k}

End if
dₖ = y_{M,k} − q̅ₖ₋₁ [symbol] H₀ [symbol] qₖ₋₁

During the step 300, the preprocessed measurements \tilde{y}_{A,k}, \tilde{y}_{M,k}, \tilde{y}_{G,k} are used by the observer. An extended Kalman filter is, for example, used in its factorized form.

We will now explain the calculation steps performed by the filter.

We will assume that we are using the second modeling. However, obviously, the first modeling can be used similarly.

The step 300 comprises the following steps:

a) A priori estimation of the state vector,
b) A priori estimation of the measurements,
c) Calculation of the gain Kₖ of the Kalman filter and of the innovation Iₖ,
d) Correction of the a priori estimated state.

The steps a) to d) will be described in detail below.

During the step a), an a priori estimation is made of the state vector at time k from the a posteriori estimation of the state vector at time k−1.

The estimation of the a priori state vector is given by:

\hat{x}ₖ⁻=\hat{x}ₖ₋₁+Te·f(\hat{x}ₖ₋₁)
with \hat{x}ₖ₋₁: a priori estimation of the state vector at time k−1,
\hat{x}ₖ⁻: a priori estimation of the state vector at time k,
Tₑ: sampling interval.

During the step b), the measurement model (III) is used to perform an estimation of the measurements using the state vector estimated in the step a):

ŷₖ⁻=h(\hat{x}ₖ⁻)

During the step c), the gain Kₖ and the innovation Iₖ are calculated, the innovation being obtained by subtracting the a priori estimated measurements from the preprocessed measurements.

The following is obtained:

$${I}_{k} = [ \begin{matrix}{\tilde{y}}_{A , k} \\ {\tilde{y}}_{M , k}\end{matrix} ] - {\hat{y}}_{k}^{-}$$

During the step d), the a priori estimated state is corrected with the gain and the innovation.

\hat{x}ₖ=\hat{x}ₖ⁻+Kₖ·Iₖ

This correction gives an a priori estimation of the orientation \hat{q}ₖ at time k. Advantageously, during a subsequent step e), the estimated quaternion is normalized

$${\hat{q}}_{k} = \frac{{\hat{q}}_{k}}{‖ {\hat{q}}_{k} ‖} ,$$

which makes it possible to avoid a drift in each step of the calculation.

The method according to the present invention offers the advantage of providing the observer with measurements that are close to disturbance-free measurements, consistent with the measurement model. The influence of the disturbances on the estimation of the orientation is therefore greatly reduced. It also makes it possible to permanently provide the observer with information originating from each of the sensors even when disturbances are present, by maintaining a constant trust in each measurement. In practice, the combined use of the measurements from the accelerometer, from the magnetometer and from the rate gyro makes it possible to reduce the influence of the measurement errors (measurement noise, remaining disturbances, remaining rate gyro bias) on the estimated orientation.

The method according to the present invention makes it possible to estimate the orientation, but also the proper accelerations and the magnetic disturbances at each sampling interval, regardless of the movement carried out up to nine degrees of freedom. Implementing this method is very simple, since it relies on the use of basic building blocks: value tests, analytical calculations, extended Kalman filter

1. A method of estimating the orientation of an object in space at time k using the measurements of the total acceleration (y_{A}), magnetic field (y_{M}) and rotation speed (y_{G}) of said object along three spatial axes, said method comprising:
A—preprocessing of said measurements (y_{A}, y_{M}, y_{G}) at a moment k to detect the existence of a disturbance in said measurements, said disturbance from a group comprising a proper acceleration of the object, a magnetic field added to the earth's magnetic field and a bias in the measurement of the rotation speed, and to estimate disturbance-free measurements at time k,
B—estimation of the orientation at time k by an observer from the estimated disturbance-free measurements (\tilde{y}_{A,k}, \tilde{y}_{M,k}, \tilde{y}_{G,k}) at time k obtained from step A.

2. The method of claim 1, wherein the estimation of the orientation of an object in space at time k uses only the measurements of the total acceleration (y_{A}), magnetic field (y_{M}) and rotation speed (y_{G}) of said object along three axes in space.

3. The method of claim 1, wherein step A comprises:
A1—a preprocessing of the rotation speed (y_{G}) measurements,
A2—a detection of the existence or non-existence of a disturbance at time k in said measurements of the total acceleration and magnetic field (y_{A}, y_{M}),
A3—in case of absence of disturbance at time k, the estimated disturbance-free measurement at time k (\tilde{y}_{A,k}, \tilde{y}_{M,k}) is equal to the measurement at time k, and in case of disturbance, the disturbance-free measurement estimated at time k (\tilde{y}_{A,k}, \tilde{y}_{M,k}) is calculated on the basis of the orientation estimated at time k−1.

4. The method of claim 3, wherein step A1 comprises subtracting, from the rotation speed measurements, an average bias (\hat{b}_{average}) determined during a preliminary initialization step.

5. The method of claim 4, wherein the average bias (\hat{b}_{average}) is obtained by immobilizing the means supplying the rotation speed measurements during a given time and calculating the average of the values of the rotation speed measurements on each axis.

6. The method of claim 3, wherein the step A2 comprises:
A2.1—a test to compare the norm of the total acceleration measurements to that of the gravitational field (G₀) wherein, if the absolute value of the difference between the norm of the accelerometric measurements at time k and that of the gravitational field (G₀) is below a predetermined threshold (α_{A}), it is assumed that the accelerometric disturbance is zero, otherwise it is assumed that there is a disturbance, the disturbance being equal, on each axis, to the difference between the measurement of the total acceleration at time k and the disturbance-free accelerometric measurement estimated at time k,
A2.2—a test to compare the norm of the magnetic field measurements to that of the earth's magnetic field (H₀) wherein, if the absolute value of the difference between the norm of the magnetic field measurements and that of the earth's magnetic field is below a predetermined threshold (α_{M}), it is assumed that the magnetic disturbance is zero, otherwise it is assumed that the magnetic disturbance is equal, on each axis, to the difference between the magnetic field measurement at time k and the disturbance-free magnetic field measurement estimated at time k.

7. The method of claim 6, wherein provision is made in the step A2.1 for an additional test on the estimated disturbance (âₖ₋₁) at time k−1: in the case where the absolute value of the difference between the norm of the measurements of the total acceleration and that of the gravitational field (G₀) at time k is below the predetermined threshold (α_{A}), a check is carried out to see whether the norm of the estimated accelerometric disturbance at time k−1 is below a predetermined threshold (β_{A}), if this test is positive, it is assumed that the accelerometric disturbance is effectively zero at time k, and/or provision is made in step A2.2 for an additional test on the estimated magnetic disturbance at time k−1 (\hat{d}ₖ₋₁) wherein, in the case where the absolute value of the difference between the norm of the magnetic field measurements and that of the earth's magnetic field (H₀) is below the predetermined threshold (α_{M}), it is checked whether the absolute value of the estimated magnetic disturbance at time k−1 is below a predetermined threshold (β_{M}) wherein, if this test is positive, it is assumed that the magnetic disturbance is effectively zero at time k.

8. The method of claim 3, wherein at least one of the detections of step A2 is performed over a time window (T_{A}, T_{M}) set by a user.

9. The method of claim 8, wherein the detection of the proper acceleration is produced by a processing of the following form:
If ∃tₖ∈[tₖ − T_{A}; tₖ] |∥y_{A,k}∥ − ∥G₀∥| > α_{A},
\tilde{y}_{A,k} = − \overline{\hat{q}}ₖ₋₁ [symbol] G₀ [symbol] \hat{q}ₖ₋₁
Else
\tilde{y}_{A,k} = y_{A,k}
End If
âₖ = y_{A,k} + \overline{\hat{q}}ₖ₋₁ [symbol] G₀ [symbol] \hat{q}ₖ₋₁

10. The method of claim 8, wherein the detection of the magnetic disturbance is performed by a processing of the following form:
If ∃tₖ∈[tₖ − T_{M}; tₖ] |∥y_{M,k}∥ − ∥H₀∥ |> α_{M},:
\tilde{y}_{M,k} = q̅ₖ₋₁ [symbol] H₀ [symbol] qₖ₋₁
else
\tilde{y}_{M,k} = y_{M,k}
End if
\hat{d}ₖ = y_{M,k} − \overline{\hat{q}}ₖ₋₁ [symbol] H₀ [symbol] \hat{q}ₖ₋₁

11. The method of claim 9, wherein is also calculated the angle uₖ=angle(−\tilde{y}_{A,k}, y_{M,k}) at the output of the detection of the proper acceleration and the detection of the magnetic disturbance is then produced by a processing of the following form:
If proper acceleration present
T_{M} = T_{M}_fast
else
T_{M} = T_{M}_slow
End if
If |∥y_{M,k}∥ − ∥H₀∥ > α_{M} or |uₖ − u₀| > αᵤ for at least one value tₖ such that
tₖ∈[tₖ − T_{M}; tₖ]:
\tilde{y}_{M,k} = q̅ₖ₋₁ [symbol] H₀ [symbol] qₖ₋₁
else
\tilde{y}_{M,k} = y_{M,k}
End if
dₖ = y_{M,k} − q̅ₖ₋₁ [symbol] H₀ [symbol] qₖ₋₁

12. The method of claim 1, wherein the observer used in step B is an extended Kalman filter.

13. The method of claim 12, wherein step B for estimating the orientation from disturbance-free measurements estimated at time k comprises:
the estimation of the a priori state vector at time k (\hat{x}ₖ⁻), from the state vector (\hat{x}ₖ₋₁) estimated a posteriori at time k−1,
the estimation of the a priori measurements at time k (ŷₖ⁻), from the estimation of the a priori state vector at time k (\hat{x}ₖ⁻),
calculation of the gain of the extended Kalman filter (Kₖ) and of the innovation (Iₖ) by calculating the difference between the disturbance-free measurements estimated at time k and the a priori estimated measurements (ŷₖ⁻),
calculation of the estimated orientation at time k (\hat{q}ₖ) by correction of the state vector estimated a priori at time k by the gain and the innovation.

14. The method of claim 13, wherein the state vector used in the extended Kalman filter contains the elements of the angular speed and of the orientation quaternion.

15. The method of claim 14, wherein the state vector used in the extended Kalman filter contains only the elements of the orientation quaternion.

16. An attitude control system comprising at least a sensing unit for supplying acceleration measurements (y_{A}), a sensing unit for measuring the magnetic field (y_{M}), a sensing unit measuring the rotation speed (y_{G}) along three spatial axes, and a processing unit for estimating an orientation at time k on the basis of the measurements supplied by said sensing units, said control system comprising:
an sub-unit for preprocessing said acceleration (yA), magnetic field (yM), and rotation speed (yG) measurements, said preprocessing sub-unit being suitable for detecting the existence of a disturbance in said measurements, said disturbance from a group comprising a proper acceleration of the object, a magnetic field added to the earth's magnetic field and a bias in the rotation speed measurement and for delivering estimated disturbance-free accelerometric measurements (\tilde{y}_{A,k}), estimated disturbance-free magnetometric measurements (\tilde{y}_{M,k}), and the non-biased rotation speed (\tilde{y}_{G,k}),
a sub-unit for estimating the orientation at a moment k by an observer from the estimated disturbance-free accelerometric measurements, the estimated disturbance-free magnetometric measurements and the non-biased rotation speed measurements supplied by the preprocessing means.

17. The attitude control system of claim 16, also comprising a module for calculating an average bias (\hat{b}_{average}) of the rotation speed measurement means during a control system initialization step.

18. The attitude control system of claim 16, wherein the preprocessing sub-unit comprises a module for detecting the existence of a proper acceleration in the acceleration measurements and a module for detecting the existence of magnetic disturbances in the magnetic field measurements.

19. The attitude control system of claim 18, wherein the module for detecting the existence of a proper acceleration in the acceleration measurements and the module for detecting the existence of magnetic disturbances in the magnetic field measurements are operable to perform these detections in one or more time windows.

20. The attitude control system of claim 16, further comprising a module for estimating the proper acceleration and the magnetic disturbance, and for calculating the speed and position of the object.

21. The attitude control system of claim 16, wherein the observer is an extended Kalman filter.

22. The attitude control unit of claim 16, wherein the sensing units for supplying measurements of the total acceleration (y_{A}), measurements of the magnetic field (y_{M}), and measurements of the rotation speed (y_{G}) along three axes in space are MEMS sensors.

23. An attitude control system comprising at least a sensing unit for supplying acceleration measurements (y_{A}), a sensing unit for measuring the magnetic field (y_{M}), a sensing unit measuring the rotation speed (y_{G}) along three spatial axes, and a processing unit comprising an sub-unit for preprocessing said acceleration (yA), magnetic field (yM), and rotation speed (yG) measurements, said preprocessing sub-unit being suitable for detecting the existence of a disturbance in said measurements, said disturbance from a group comprising a proper acceleration of the object, a magnetic field added to the earth's magnetic field and a bias in the rotation speed measurement.

24. The attitude control system of claim 23, wherein a combination of the output of the sensing units and the preprocessing sub-unit is used to provide an estimation of the position of an object carrying the sensing units.
